(19) United States
(12) Patent Application Publication
(10) Pub. No.: US 2020/0063291 A1
(43) Pub. Date: Feb. 27, 2020

(54) AN APPARATUS AND METHOD FOR SPREADING FIBRES

(71) Applicant: HEXCEL COMPOSITES LIMITED, Duxford, Cambridgeshire (GB)

(72) Inventors: John ELLIS, Duxford (GB); Marco ARCIDIACONO, Duxford (GB); Andrea CABALLERO, Baldock (GB)

(73) Assignee: HEXCEL COMPOSITES LIMITED, Duxford, Cambridgeshire (GB)

(21) Appl. No.: 16/344,121

(22) PCT Filed: Oct. 27, 2017
(86) PCT No.: PCT/EP2017/077703

§ 371 Date: Apr. 23, 2019

(30) Foreign Application Priority Data
Nov. 11, 2016 (GB) 1619146.2

(51) Int. Cl. D01D 11/02; B29B 15/12; D02J 1/18

(52) U.S. Cl. CPC D01D 11/02; B65H 51/005; D02J 1/18; B29B 15/12

(57) ABSTRACT

A fiber tow spreading apparatus comprising: fiber supply for supplying a fiber tow; a fiber spreader for spreading the filaments of the fiber tow to form a spread tow having an increased width; a guide member for directing the fiber tow in relation to the fiber spreader; a driver for driving the fiber tow in relation to the fiber spreader; wherein the driver comprises a moveable contacting surface to which the fiber is adhered.

The present invention relates to an apparatus and a method for spreading fibres, particularly but not exclusively to a spreading apparatus for the expansion of the width of fiber tows, and a method adapted to expand the width of fiber tows.

### BACKGROUND

Fiber tows comprise multiple individual fibre filaments. By spreading the fiber tows, the number of filaments per unit of width of the fiber tows is reduced. In this way, the weight of the tow per unit of width is reduced. This in turn allows the manufacture of light weight fabrics containing multiples of such spread tows.

Apparatus and processes for spreading individual and multiple fiber tows are disclosed in many publications. Examples of such disclosures are described now.

EP1548166 discloses a fibre tow spreading machine for converting bundled fibres comprising multiple filaments into a flat tape of spread filaments. The invention uses continuous airflow perpendicular to the tows to spread the fiber tows.

EP2436809 discloses another method for spreading fibre bundles in which an air flow spreads fibers tows which are allowed to bend in the air flow.

EP0837162 discloses a multi-filament spread tow sheet, and method and device for the manufacture thereof. The sheet is produced by the steps of supplying multiple fiber tows in an overfeed condition from a supply means to a winding means and by subjecting the fiber tows to an air flow whilst they are supported on support bars.

As is clear from these disclosures, when spreading fiber tows, it is important that their tension is reduced and is as low as possible to enable effective spreading of the tows. These spread tows are conventionally wound onto a spool after spreading. However, winding increases the tension in the spread tow which results in a reduction of its spread width because with increased tension the fibre tow collapses.

The present invention aims to obviate or at least mitigate this problem and/or to provide improvements generally.

According to the invention there is provided an apparatus and a method as defined in any one of the accompanying claims.

In an embodiment of the invention there is provided a fiber tow spreading apparatus comprising: fiber supply for supplying a fiber tow; a fiber spreader for spreading the filaments of the fiber tow to form a spread tow having an increased width; a guide member for directing the fiber tow in relation to the fiber spreader; a driver for driving the fiber tow in relation to the fiber spreader; wherein the driver comprises a moveable contacting surface to which the fiber is adhered.

Following spreading through exposure to the fiber spreader the fiber is directly in contact with the contacting surface without being exposed to any intermediate processing steps which reduce the width of the spread tow. The contacting surface stabilizes or fixes the spread configuration of the tow and drives the tow in relation to the fiber spreader.

The apparatus is adapted to spread an individual tow, but the apparatus may also be adapted to spread multiple tows. As the spread fiber tow or tows are adhered to the contacting surface, the tows do not reduce in width following their exposure to the spreading unit.

Any tension which is applied to the tow following its exposure to the fiber spreader is disposed of by its adherence to the contacting surface. In this way, the invention allows the spread tows to be processed by subsequent steps such as handling and winding without their width being reduced during subsequent processing steps following spreading.

In an embodiment, the apparatus is adapted to spread multiple tows. In this embodiment, the fiber supply provides a plurality of fiber tows and the fiber spreader spreads the filaments of each of the plurality of fiber tows to form a sheet. The sheet may be continuous or may comprise discrete spaced spread tows. Multiple tows can be supplied from a creel in which multiple spools or bobbins of fiber tows are placed.

In a further embodiment, the contacting surface contacts the spread fiber tow. The contacting surface drives the spread tow through the apparatus.

In a preferred embodiment, the contacting surface comprises a tack surface for tacking the spread fiber tow to its surface. The tack surface secures the spread tow or tows.

The contacting surface may be in the form of a resin layer. The resin layer has a surface tack upon a first point of contact with the tow to allow the spread fiber tow to adhere to its surface. The surface tack of a resin is an inherent property of the resin. Tack in resins is dependent on temperature. Thus tack can be controlled by controlling the temperature of the resin. Within the context of this invention, contacting with the contacting surface preferably occurs at room temperature and the tack of the resin at room temperature is sufficient to adhere the fiber tow to its surface.

In a preferred embodiment, the fiber tow adheres to the resin layer from the first point of contact and downstream from the point of contact when viewed in the direction of movement of the surface.

In this way, the spread tow or tows are located onto the resin layer after being exposed to the fiber spreader. Thus, a spread tow and resin ensemble is formed.

The presence of the resin layer stabilizes the spread tow and allows these to be exposed to subsequent forces associated with subsequent processing steps such as impregnation, slitting and winding without the spread fiber reducing in width or distorting in any way.

The resin layer is in sheet form and may be located on a release layer. The release layer is removable to allow deposition of the resin layer and tow ensemble.

Preferably, the spread fiber tows form a sheet which his adhered to the resin layer.

In a further embodiment of the invention the fiber spreader comprises a spreading surface which contacts the fiber tow, the first point of contact of the contracting surface with the spread tow being elevated in relation to the spreading surface. This ensures the fiber tows is in contact with the contacting surface over a significant contact area to ensure adequate contact for driving the tow in relation to the fiber spreader. The contacting surface may be inclined following the first point of contact. This further increases the contact area between the surface and the tow. This is particularly useful for multiple spread tows which form a continuous sheet of spread fibers.

In another embodiment, the apparatus comprises a guide member, the guide member comprising multiple spaced guide elements. The guide member controls the width of the tow as it is supplied to the fiber spreader. For multiple tows, the guide member maintains adequate spacing between the multiple fiber tows.

The spacing d between the multiple spaced guide elements is preferably adjustable. The guide member is arranged at an angle β in relation to the direction of the tows, to expose the tows to an aperture w which is directly proportional to the spacing width d between guide members and sin β. The density of the fiber tows may then be defined as number of filaments/unit of width is directly proportional to d·sin β. The width of the tow following the guide member is w=d·sin β.

In a further embodiment of the invention, the spacing between the guide elements d controls the density of the spread filaments of the tow or tows across the spread sheet.

The spread unit may comprise any of the conventional apparatus for spreading fiber tows, such as the apparatus described in EP1548166, EP2436809 or EP0837162 as briefly disclosed in this application.

In another embodiment of the invention the apparatus comprises a resin impregnation section. In this way, the apparatus is integrated into an impregnation machine to produce tow preg or prepreg from a respective a spread tow, or from multiple spread tows. The resin impregnation section further comprises means for at least partially impregnating the spread sheet, said means comprising compression equipment, heating equipment or a combination of the aforesaid equipments.

In yet another embodiment of the invention there is provided a method of spreading a fiber tow comprising providing a fiber supply for supplying a fiber tow; a fiber spreader for spreading the filaments of the fiber tow to form a spread sheet; a guide member for directing the fiber tow in relation to the fiber spreader; a driver for driving the fiber tow in relation to the fiber spreader; the method further comprising the steps of directing the fiber tow from the fiber supply to the fiber spreader and providing a fiber adhering contacting surface, wherein the fiber adhering contacting surface is movable to drive the tows over the fiber spreader.

The contacting surface secures the fiber tow in its spread configuration so that the contacting surface stabilizes the spread fiber tow. This allows the fiber tows to be pulled from the fiber supply by exerting a pull force on the contacting surface and this force does not result in a distortion or a reduction in width of the fiber tow.

This is an important advantage over known methods for spreading fiber tows in which the spread tows are subjected to distortion due to forces to which the tows are exposed following their spreading.

Preferably, the method is adapted to spread multiple tows, the spread tows forming a sheet. The method may further comprise the step of impregnating the tow or tows.

The invention will now be described by way of example only and with reference to the accompanying drawings in which

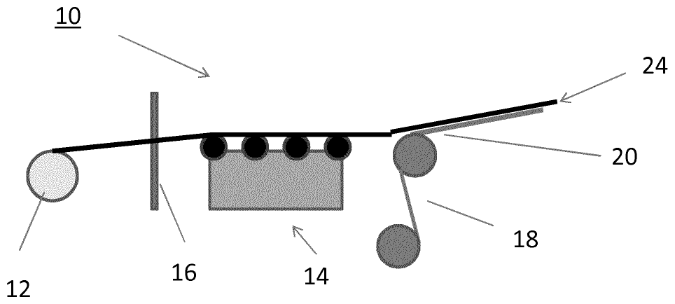

FIG. 1 presents a diagrammatic view of an apparatus according to an embodiment of the invention;

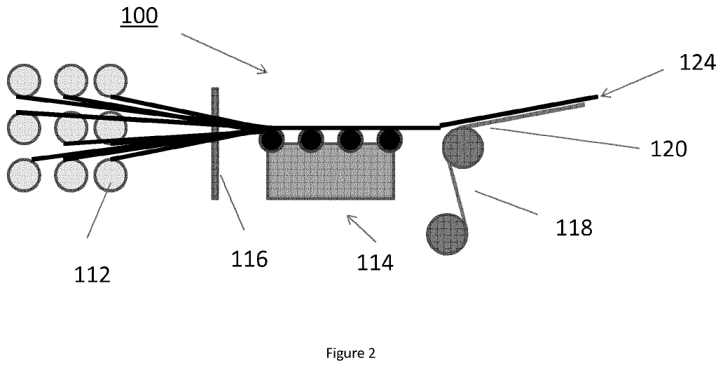

FIG. 2 presents a diagrammatic view of another apparatus according to another embodiment of the invention; and

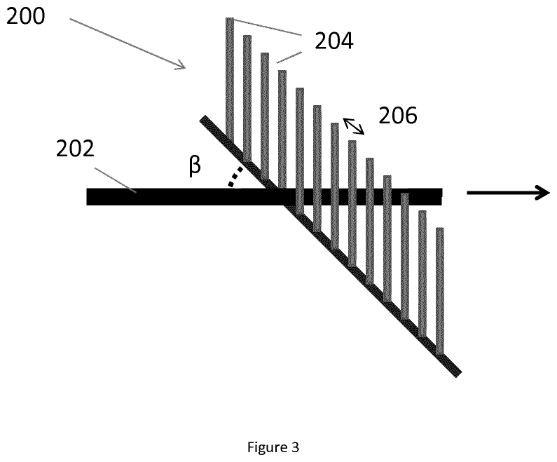

FIG. 3 present a diagrammatic view of a guide member according to a further embodiment of the invention.

In FIG. 1 a spreading apparatus 10 is shown which comprises a fiber supply for supplying a fiber tow 12; a fiber spreader 14 for spreading the filaments of the fiber tow 12 to form a spread tow having an increased width; a guide member 16 for directing the fiber tow in relation to the fiber spreader 14; and, a driver 18 for driving the fiber tow 12 in relation to the fiber spreader 14. The driver 18 comprises a moveable fiber adhering contacting surface 20 to which the spread fiber tow 12 is adhered.

The fiber supply 12 is in the form of a bobbin mounted on a creel so that it is freely rotating. So the fiber tow is driven and exposed to the fiber spreader 14 by means of the moving contacting surface 20 to which the fiber tow is adhered. The adhesion to the contacting surface is achieved by a resin film which is located on a carrier or substrate which is in the form of a release film. The carrier or substrate is moved by the driver rollers 18. The resulting product 24 is thus an ensemble of the spread tow in combination with a resin film located on a release film as substrate.

The contact surface which first contacts the fiber tow is elevated in relation to the spreading surface of the fiber spreader. This results in a secure contact between the tow and the contact surface and enables adherence between the tow and the contacting surface so that the contacting surface can drive the tow. As shown in FIG. 1, the contacting surface is also inclined and roller 22 is used to conduct the tow to the contacting surface to ensure a large contacting area between the tow and the contacting surface. The larger contacting area promotes adhesion between the resin layer and the fiber tow.

In use, a fiber tow 12 is supplied from a bobbin and guided by member 16 to a fiber spreader 14 which spreads the tow 12. FIG. 2 presents a similar apparatus to the apparatus of FIG. 1 but this apparatus 100 is adapted to form an ensemble 124 of a resin layer in combination with spread tows which form a sheet.

The apparatus 100 comprises a fiber supply 112 in the form of a creel with multiple freely rotating fiber spools or bobbins for supplying multiple fiber tows; a fiber spreader 114 for spreading the filaments of the fiber tows to form a spread tow sheet of combined spread tows; a guide member 116 for directing the fiber tows in relation to the fiber spreader 114; a driver 118 for driving the fiber tows in relation to the fiber spreader 114. The driver 118 comprises a moveable fiber adhering contacting surface 120 to which the spread fiber tows are adhered.

The fibers tows are thus adhered to the exposed resin film layer to form an ensemble of the resin film and spread fiber layer.

The adhesion to the contacting surface is achieved by a resin film which is located on a carrier or substrate. The carrier or substrate is moved by the driver 118. The resulting product 124 is thus an ensemble of the spread tow in combination with a resin film.

The contact surface which first contacts the fiber tows is elevated in relation to the spreading surface of the fiber spreader similar to the apparatus of FIG. 1.

In use, a fiber tows are supplied from a creel 112 loaded with multiple bobbins and guided by member 116 to a fiber spreader 114 which spreads the tows. The resin film 120 is driven through by driver 118.

Finally, FIG. 3 shows further aspects of the guide members 16,116, referenced as 200 in this Figure. For clarity the guide member 200 is shown with a single tow 202.

The guide member 200 comprises multiple guide elements 204 which are equi-spaced at a distance d 206. The guide member 200 is further angled in relation to the tow by an angle 62. The ange reduces the effective spacing of the guide elements 204 to an angle w=d·sin β. This results in a reduction in the width of the tow but more importantly, it also allows control of the density per unit width of the tow (number of filaments per mm) which in turn effects the density of the spread tow as it passes over the spreading unit.

The angle β of the guide member thus enables control of the density per unit width of the spread tow or in case of multiple tows, spread fiber tows because the density is directly proportional to d·sin β.

There is thus provided an apparatus for spreading fiber tow(s) in which the width of the tows is fixed following their exposure to the spreading unit by their direct adherence to a contacting surface which drives the tows in relation to the spreading unit without any intermediate process steps. The apparatus can comprise an impregnation unit to manufacture resin impregnated fiber reinforced material (also known as prepreg) from spread tows.

1. A fiber tow spreading apparatus comprising:
a. a fiber supply for supplying a fiber tow;
b. a fiber spreader for spreading the filaments of the fiber tow to form a spread tow having an increased width;
c. a guide member for directing the fiber tow in relation to the fiber spreader;
d. a driver for driving the fiber tow in relation to the fiber spreader;
wherein the driver comprises a moveable fiber adhering contacting surface to which the fiber is adhered.

2. An apparatus according to claim 1, wherein the spread tow is contacted with the driver without being exposed to any process steps which reduce the width of the tow following its exposure to the spreader.

3. An apparatus according to claim 2, wherein the tow is directly in contact with the contacting surface following its exposure to the fiber spreader.

4. An apparatus according to claim 3, wherein the fiber supply provides a plurality of fiber tows and the fiber spreader spreads the filaments of each of the plurality of fiber tows to form a continuous spread sheet.

5. An apparatus according to claim 4, wherein the contacting surface contacts the spread fiber tow.

6. An apparatus according to claim 5, wherein the contacting surface comprises a tack surface for tacking the spread fiber tows to its surface.

7. An apparatus according to claim 6, wherein the contacting surface is in the form of a resin layer.

8. (canceled)

9. (canceled)

10. An apparatus according to claim 7, wherein the fiber spreader comprises a spreading surface which contacts the fiber tow, the first point of contact with the spread tow being elevated in relation to the spread tow.

11. An apparatus according to claim 10, wherein the spreading surface following the first point of contact with the surface is inclined.

12. An apparatus according to claim 11, wherein the guide member comprises multiple spaced guide elements.

13. An apparatus according to claim 12, wherein the spacing d between the multiple spaced guide elements is adjustable.

14. An apparatus according to claim 13, wherein the guide member is arranged at an angle β in relation to the direction of the tows, to expose the tows to an aperture which is directly proportional to the spacing width w between guide members and sin β.

15. An apparatus according to claim 14, wherein the density of the fiber tows defined as number of filaments/unit of width w is directly proportional to d·sin β.

16. An apparatus according to claim 15, wherein the spacing d between the guide elements controls the density of the spread filaments of the tow or tows across the spread sheet.

17. An apparatus according to claim 16 comprising a resin impregnation section.

18. An apparatus according to claim 17, wherein the resin impregnation section further comprises means for at least partially impregnate the spread sheet, said means comprising compression equipment, heating equipment or a combination of the aforesaid equipments.

19. A method of spreading a fiber tow comprising providing
a. a fiber supply for supplying a fiber tow;
b. a fiber spreader for spreading the filaments of the fiber tow to form a spread sheet;
c. a guide member for directing the fiber tow in relation to the fiber spreader;
d. a driver for driving the fiber tow in relation to the fiber spreader;
the method further comprises the steps of directing the fiber tow from the fiber supply to the fiber spreader and providing a fiber adhering contacting surface,
wherein the fiber adhering contacting surface is movable to drive the tows over the fiber spreader.

20. (canceled)

21. (canceled)

22. A method according to claim 19, wherein the contacting surface stabilizes the spread fiber tow.

23. (canceled)

24. (canceled)

25. (canceled)
